(19) United States
(12) Patent Application Publication
(10) Pub. No.: US 2008/0192969 A1
(43) Pub. Date: Aug. 14, 2008

(54) HEARING AID HAVING SELECTABLE PROGRAMMES, AND METHOD FOR CHANGING THE PROGRAMME IN A HEARING AID

(75) Inventor: David WELNER, Lyngby (DK)

Correspondence Address: SUGHRUE MION, PLLC, 2100 PENNSYLVANIA AVENUE, N.W., SUITE 800, WASHINGTON, DC, 20037, US

(73) Assignee: Widex A/S, Varlose (DK)

(21) Appl. No.: 12/103,616

(22) Filed: Apr. 15, 2008

Related U.S. Application Data
(63) Continuation-in-part of application No. PCT/DK2006/050050, filed on Oct. 2, 2006.

(30) Foreign Application Priority Data
Oct. 17, 2005 (DK) PA200501459

(51) Int. Cl. H04R 25/00

(52) U.S. Cl. 381/314

(57) ABSTRACT

A hearing aid (1) has a number of selectable programmes for different listening situations. The hearing aid (1) is adapted for the use with different input sources (3). The hearing aid comprises means for automatically selecting an appropriate programme among the number of the selectable programmes in dependence of the input sources used. There is also described a method for changing the programme in a hearing aid (1), wherein the programme used by the hearing aid is automatically changed by said hearing aid (1) from a first programme to a second programme in response to the selection of an additional, or alternative, input source (3).

### RELATED APPLICATIONS

The present application is a continuation-in-part of application No. PCT/ DK/DK2006/050050; filed on Oct. 2, 2006, in Denmark and published as WO2007045253, the contents of which are incorporated here-into by reference.

The present invention is based on, and claims priority from PA200501459, filed on Oct. 17, 2005, In Denmark, the contents of which are incorporated hereinto by reference.

### BACKGROUND OF THE INVENTION

1. Field of the Invention

The present invention relates to hearing aids. The invention, more specifically relates to a hearing aid having a number of selectable programmes for different listening situations, where said hearing aid is adapted for the use with different input sources. The present invention moreover relates to a method for changing the programme in such a hearing aid.

2. Prior Art

It is commonly known to use several input sources in connection with hearing aids. Such input sources may inter alia comprise several microphones, an FM radio receiver, and a telecoil pick-up. Usually the hearing aid has a number of user selectable programmes for various listening situations.

U.S. Pat. No. 4,471,171, U.S. Pat. No. 4,425,481, and U.S. Pat. No. 4,187,413, the contents of which are incorporated herein by reference, describe hearing aids with user selectable programs.

Ideally, each user selectable programme uses the best possible combination of input sources, in order to allow the user to hear those sounds of interest to him. Prior art hearing aids consequently have a number of user selectable programmes. Thus, in the street the user could select a programme “Street” with a high degree of omnidirectionality, allowing him to be aware of the traffic around him, this programme then emphasising the signals from the omnidirectional microphone, and suppressing or even excluding the signals from the directional microphones. In a personal conversation in an otherwise quiet room the user could select a programme “Conversation” with a high degree of directionality, i.e. with the emphasis on the directional microphones. In a conversation in noisy surroundings, such as a cocktail party, emphasis of a programme “Cocktail” would be on the directionality, and suppression or exclusion of the signals from the omnidirectional microphones. Similarly a programme “Auditorium”, suitable for distributed high noises scattered around the user, but with an emphasis on the forward directionality so as to hear the speaker at the lectern in the bottom of the auditorium, could be used.

For situations where the best possible combination of input sources include more specialized input sources, such as telecoil pickups or FM radio, the prior art hearing aids have user selectable programmes, e.g. “Telecoil” or “FM”, for these. The term specialized in this context signifies that these sources, unlike microphones, cannot be used everywhere, but only where appropriate infrastructure exists. Typical places where such infrastructure exists are auditoriums, churches and other places where audiences are addressed.

In such places the user will have to switch to the programme “Telecoil” or “FM” in order to better hear e.g. the speaker.

The problem with the prior art is that the user selectable programme for the specialized sources may be good for use with the specialized source, but not necessarily good for the user in the remainder of the environment in which the specialized source is used. Moreover it may not suit the preferences of the user.

Another problem arising by including programmes for all possible combinations of input devices and listening situations is that, the user may be presented with far too many options, to be able to cope with them.

DE-A-1020040526991, which is incorporated herein by reference, discloses a hearing aid in which the hearing aid attempts to determine the current listening situation, in order to present the user with a reduced set of selectable programmes. The user himself must then select the appropriate programme.

It is the object of the present invention to overcome the above problems.

### SUMMARY OF THE INVENTION

According to a first aspect of the invention this object is achieved by a hearing aid having a number of selectable program for different listening situations, wherein said hearing aid is adapted for the use with different input sources, and wherein said hearing aid comprises means for automatically selecting an appropriate programme among said number of the selectable programmes in dependence of the input sources used, said means for automatically selecting an appropriate programme comprising means for detecting the activation of an additional, or alternative, input source and for selecting said appropriate programme in dependence of said detection, wherein said means for automatically selecting an appropriate programme is furthermore adapted to select an appropriate programme in dependence of the first programme selected prior to the time of said detection.

Having the hearing aid itself and not the user selecting the appropriate programme, allows the use of far more programmes for the hearing aid than the normal user could cope with in terms of selecting an appropriate one. Thus, rather than having to select a specific programme for the use with a specialized input source, or having to select an appropriate programme among a multitude of programmes for numerous specific situations, the user only has to select one, leaving the rest of the selection to the hearing aid.

According to a second aspect of the invention the object is achieved by A method for changing the programme in a hearing aid, wherein the programme used by said hearing aid is automatically changed by said hearing aid from a first programme to a second programme in response to the selecting of an additional, or alternative, input source, wherein said second programme is selected in dependence of the first programme selected prior to the time of said selection.

The user will thus not have to select more than one programme, as the hearing aid, implementing the method according to the invention, will select a more appropriate programme the moment an additional, or alternative, input source is activated.

According to a preferred embodiment of the hearing aid according to the invention, the means for automatically selecting an appropriate programme comprises means for detecting the attachment of an additional, or alternative, input source to the hearing aid and selecting the appropriate programme in dependence of the detection. Thus, if the additional, or alternative, input source is an auxiliary part to be attached to the hearing aid, the hearing aid will automatically select the most appropriate programme upon attachment to the additional, or alternative, input source.

According to a preferred alternative embodiment of the hearing aid according to the invention, the means for automatically selecting comprises means for detecting user activation of an additional, or alternative, input source to the hearing aid and selecting the appropriate programme in dependence of the detection. Thus, if the additional, or alternative, input source is a built-in facility of the hearing aid, the user will only have to activate the source, upon which the hearing aid switches to the most appropriate programme.

According to a further preferred embodiment of the hearing aid according to the invention, the means for automatically selecting an appropriate programme is furthermore adapted to select an appropriate programme in dependence of a first programme currently selected at the time of the detection. This allows the user to simply select the most appropriate programme for the situation, e.g. “Auditorium” when he enters. Then, when the speaker addressing the audience using a telecoil loop or an FM radio transmitter comes on, the user only needs to activate the telecoil pickup or the FM receiver, respectively, and the hearing aid will automatically switch to the most appropriate programme.

According to yet another preferred embodiment, the hearing aid according to the invention further comprises means for detecting the removal of an additional, or alternative, input source to the hearing aid and returning the hearing aid to the first programme. Thus, when the speaker stops using the telecoil or the FM radio, the user can simply remove the telecoil pickup or the FM receiver, upon which the hearing aid will return to the programme “auditorium”.

Similarly, the hearing aid according to the invention may comprise means for detecting user deactivation of an additional, or alternative, input source to said hearing aid and returning the hearing aid to the first programme, if the hearing aid is of the type having built-in telecoil pickup or FM receiver.

According to a preferred embodiment of the hearing aid according to the invention, at least some of the appropriate programmes may only be selected automatically. This reduces the number of choices, which the user has to choose between, and the risk of selecting an inappropriate programme for a given situation.

According to a preferred embodiment of the method according to the invention, the programme is automatically changed in response to user selection of an additional, or alternative, input source. Thus, the user only needs to select an appropriate programme for the listening environment. Then, later, when the additional source is activated, the hearing aid, in which the method is implemented, automatically selects an appropriate programme.

According to one preferred embodiment of the method according to the invention, the user selection is effected through the attachment of an additional, or alternative, input source to the hearing aid. Thus, the user needs only perform one action, i.e. attaching the additional, or alternative, input source to the hearing aid. He does not subsequently need also to manually select this source.

According to yet another preferred embodiment of the method according to the invention, the second programme is selectable only by the hearing aid. As indicated above, this reduces the number of options which the user has to cope with.

### BRIEF DESCRIPTION OF THE DRAWINGS

The invention will now be described in greater detail, based on non-limiting exemplary embodiments in connection with the drawings. In the drawings,

FIG. 1 is flow chart of the method according to the invention, and

FIG. 2 is a hearing aid according to the invention

### DETAILED DESCRIPTION OF THE DRAWINGS

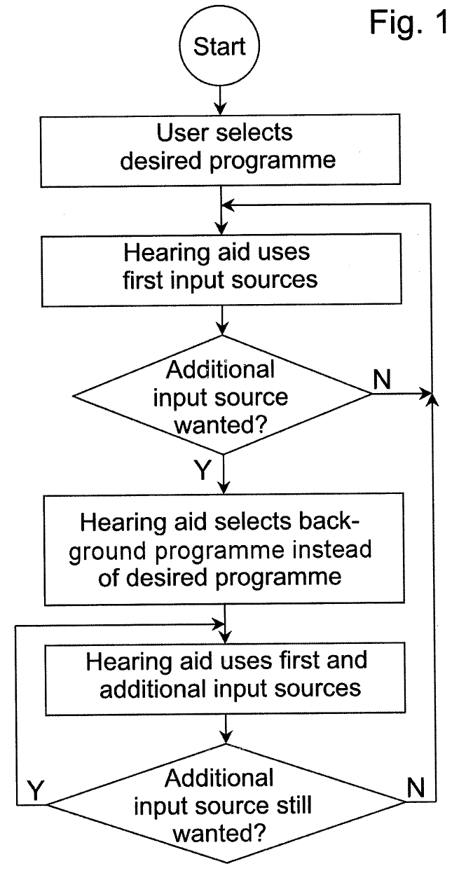

In FIG. 1 an embodiment of the method according to the invention is depicted as a flow chart.

The method according to the invention starts in box 101. Then, in box 102, the user selects a desired programme among a number of user selectable programmes. Incorporating such selectable programmes in hearing aids is well known. Information to this can be found in the patents U.S. Pat. No. 4,471,171, U.S. Pat. No. 4,425,481 and U.S. Pat. No. 4,187,413 incorporated herein by reference. This programme could be one among numerous such as “Street”, “Conversation”, “Cocktail” or “Auditorium”.

Some of these user selectable programmes may have associated background programmes according to the invention, which are not user selectable, e.g. “Auditorium with Telecoil” or “Auditorium with FM radio”.

If the user selects “auditorium”, the hearing aid will start, in box 103, using the settings for this programme as set up during the initial fitting of the hearing aid to the user, thereby using a first group of input sources, giving the desired match of directionality and omnidirectionality in respect of parameters such as amplification and signal strength as well as noise suppression and the like.

Presuming now that the user is sitting in an auditorium fitted with an FM radio transmitter via which the speech of a lecturer can be heard, and that the user wants to use this option, he or she activates the FM receiver as an additional, or alternative, input source. If the FM receiver is built-in in the hearing aid this can be done by pressing an appropriate button, e.g. on a remote control or on the hearing aid itself. If the FM receiver is not built-in he or she may instead attach an additional FM receiver to the hearing aid.

Box 104 represents a detection means for detecting the selection of an additional, or alternative, input source such as an FM receiver. If, or when, in box 104 the detection means in the hearing aid detects the selection of the additional, or alternative, input source, in box 105 the hearing aid selects an appropriate background programme, where e.g. the level of the input signal from the FM receiver matches the level of the first input sources.

If no background programme is associated with the user selected programme, e.g. because the user has forgotten to switch away from the “Street” programme, the hearing aid may first switch to an alternative programme, e.g. “Auditorium”, and then subsequently switch to the background programme “Auditorium with FM radio”. As an alternative to the automatic selection, the hearing aid may just point the user to one or more programmes having an associated background programme, allowing the user to decide himself which one to use. Here it should be noted that “Street” is just an example of a programme, where no background programme exists. It does not exclude that “Street” could have an associated background programme for FM radio. The latter is merely a matter of fitting. In principle background programmes could be associated with all first programmes during the initial fitting of the hearing aid to the user. Alternatively they could all be inherently present in the hearing aid from the production thereof, e.g. coded therein.

From this point the hearing aid uses the background programme “Auditorium with FM radio” selected in box 105 using both first and second input sources as indicated in box 106, until, in box 107, the deselection of the additional, or alternative, input source is detected. The de-selection evidently could be both the detachment of the attached additional, or alternative, input source, or the deactivation of a built-in additional, or alternative, input source.

When the hearing aid detects the de-selecting of the second or additional input source, it returns to using the first input sources in box 103 in accordance with the user selected programme as originally selected in box 102. Alternatively, if the originally selected programme did not have an associated background programme, and a background programme associated with another programme was selected, the hearing aid could return to that programme instead. In the example above that would mean returning from “Auditorium with FM radio” to “Auditorium” instead of “Street”.

It should be noted that it is not necessarily so that each of the first programmes, which has associated background programmes, has it's own set of unique background programmes. In order to save storage space for the parameters and the like associated with each of the programmes, it may be convenient to associate the same background programme with several first programmes. An example could be similar programmes, such as a general programme for “Low noise”, a programme “Auditorium” or a program “Church”, which would all direct to the same background programme, the moment the telecoil pickup is activated or attached.

Moreover it should be noted that in order to save storage space in the hearing aid it is not necessary to allocate a full programme location in order to code the parameters of a background programme. If e.g. a user selectable programme comprises the following parameters or control data blocks: overall gain for the programme, gain in individual frequency bands and control parameters for directionality, then it would for the volume balance between microphones and e.g. FM receiver only be necessary to store a data block with the overall gain for the FM receiver, with which the gain can the be adjusted in relation to the overall gain for the programme.

Similarly, if the use of an additional, or alternative, input source only necessitates a compensation for the frequency characteristics, it is sufficient to store gain values for the individual bands. In one embodiment these may be stored as additive values. Thus, a gain setting is stored, and when the background programme is activated, the value is added to the corresponding parameters of the first programme. How this is done depends on the actual construction of the hearing aid, but is within reach of the skilled person.

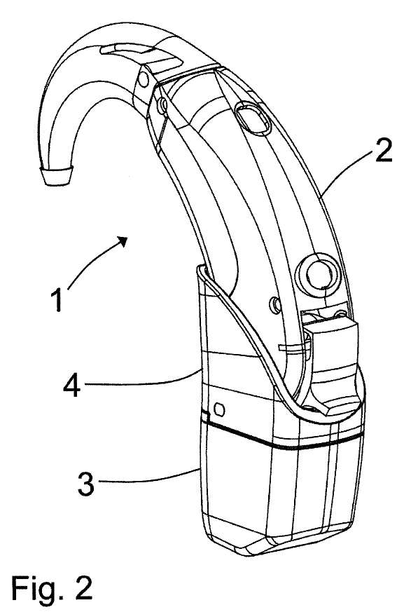

FIG. 2 illustrates a hearing aid 1 according to the invention. The hearing aid comprises a housing 2, containing the electronics including input microphones. An additional input device 3, such as an FM receiver or a telecoil pickup, has been attached to the hearing aid 1 via a shoe 4. Upon the detection by the hearing aid 1 that the additional input device has been attached, the hearing aid 1 changes the programme from the currently selected programme using the first input sources, i.e. the built-in microphones, to a background programme using the first input sources and second input sources, such as a telecoil pickup or an FM radio receiver in the additional input device 3, as the case may be.

It is also conceivable to have the possibility of using a plurality of different types of additional input devices, so that e.g. multiple different types of FM receivers can be used with the hearing aid. Each input device may be assigned a specific device identification code to identify the type of input device to the hearing aid, and the identification code may be taken into account in the selection of programme. Hence in a system adapted for selection of an input device among M devices of N different types, a total of M×N programme storage positions are required. If J different types of FM receivers form part of the N different types of devices, then the device identification code will point to which of the J specific storage positions to be used. The identification code can be passive, e.g. by a set of contacts making up a binary code, or active so that a binary code is transmitted to the controller choosing among the programmes.

In a particularly simple embodiment the user cannot select programme, i.e. there is only one user selectable programme, but one or more background programmes.

1. A hearing aid having a number of selectable program for different listening situations, wherein said hearing aid is adapted for the use with different input sources, and wherein said hearing aid comprises means for automatically selecting an appropriate programme among said number of the selectable programmes in dependence of the input sources used, said means for automatically selecting an appropriate programme comprising means for detecting the activation of an additional, or alternative, input source and for selecting said appropriate programme in dependence of said detection, wherein said means for automatically selecting an appropriate programme is furthermore adapted to select an appropriate programme in dependence of the first programme selected prior to the time of said detection.

2. The hearing aid according to claim 1, comprising means for detecting the removal of an additional, or alternative, input source to said hearing aid and returning the hearing aid to the first programme.

3. The hearing aid according to claim 1, comprising means for detecting user deactivation of an additional, or alternative, input source to said hearing aid and returning the hearing aid to the first programme.

4. The hearing aid according to claim 1, wherein at least some of said appropriate programmes may only be selected automatically.

5. A method for changing the programme in a hearing aid, wherein the programme used by said hearing aid is automatically changed by said hearing aid from a first programme to a second programme in response to the selecting of an additional, or alternative, input source, wherein said second programme is selected in dependence of the first programme selected prior to the time of said selection.

6. The method according to claim 5, wherein the programme is automatically changed in response to user selection of an additional, or alternative, input source.

7. The method according to claim 6, wherein said user selection is effected through the attachment of an additional, or alternative, input source to the hearing aid.

8. The method according to claim 5, wherein the second programme is selectable only by the hearing aid.
